(19) United States
(12) Patent Application Publication
(10) Pub. No.: US 2012/0293800 A1
(43) Pub. Date: Nov. 22, 2012

(54) DEVICE AND METHOD FOR DETECTING BIOLOGICAL MATERIAL

(75) Inventors: Martina Gerken, Kiel (DE); Yousef Nazirizadeh, Wiesbaden (DE)

(73) Assignee: CHRISTIAN-ALBRECHTS-UNIVERSITAET ZU KIEL, Kiel (DE)

(21) Appl. No.: 13/574,809

(22) PCT Filed: Jan. 19, 2011
(86) PCT No.: PCT/DE11/00051

§ 371 Date: Jul. 24, 2012

(30) Foreign Application Priority Data
Jan. 26, 2010 (DE) 10 2010 005 859.9

(51) Int. Cl. G01N 21/59

(52) U.S. Cl. 356/364

(57) ABSTRACT

The invention relates to a device for detecting biological materials, comprising a light source (1) that radiates light (2) into an object (5), a photonic crystal brought into contact with the object, a detector (8) that detects light (7) transmitted through the photonic crystal (6) and the object, a first polarization filter (3) arranged between the light source (1) and the photonic crystal (6), and a second polarization filter (4) arranged between the object (5) and the detector (8) and rotated 90° relative to the first polarization filter (3), wherein the source (1) and the photonic crystal (6) are matched to each other such that the resonances caused by the photonic crystal (6) and the resonances caused by the interaction of the photonic crystal (6) with the object (5) lie in an edge range of the emission spectrum of the light source (1).

The invention relates to a device and a method for detecting biological material or biological substances on the basis of a transmitted-light metering path according to the preamble of claim 1, into which the organic/biological substance to be determined, a filter bank, a photonic crystal and an optical receiver for evaluating the transmitted signal are incorporated.

Detecting biological substances such as for example DNA, anti-genes, enzymes or bacteria is of increasing importance in the daily lab work and in some scientific areas.

Regarding the prior art of the detection of these substances, up till now all these samples were detected chemically with the aid of fluorescence markers or analyzed using electrical sensor such as for example using electrochemical sensors, quartz crystal microbalance sensors, surface resonance sensors, by means of optical spectrometry methods and by devices that utilize the specific optical absorption of components to be analyzed (see also US 2006 0 188 398 A1). These different methods are disclosed in Kuzmany, H., Festkörperspektroskopie, Springer Verlag, Heidelberg 1990, pages 133-135, in the unexamined German application DE 100 63 151 A1 and in the patent specification DE 103 10 645 B3. A particularly sensitive detection method is mentioned in the European patent specification EP 1 125 117 B1 that can detect very small amounts of material on a crystal that can oscillate, by means of a resonance shift with a high signal noise ratio.

There is also known in B. T. Cunningham et al., Label-free assays an the BIND system, Journal of Biomolecular Screening 9, p. 481-490 (2004) a method for detecting biological substances where the substance to be detected is placed on a planar photonic crystal, the photonic crystal functioning as a transductor, so as to determine the substance on the crystal surface by means of a change in resonance. The technical application is set out in the US patent specification U.S. Pat. No. 7,158,230 B2. However a spectrometer is requisite for a quantitative evaluation of the transmitted signals. The literature also mentions a method that uses a photonic crystal as transductor for biosensor application in that the wave-guiding modes are used [M. Wiki and R. E. Kunz, Wavelength-interrogated optical sensor for biochemical applications, Opt. Lett. 25, p. 463-465 (2000)].

As a disadvantage, all disclosed devices and evaluation methods have in common that either they require a high level of technical sensor setup that is frequently connected with high costs, that additional equipment is partly necessary for signal valuation, that they do not guarantee a sufficient signal-noise ratio without additional circuit measures and mostly require trained lab staff for implementation and evaluation.

The object of the invention is to provide a device and a method that makes do with a simple measurement setup, does not require any additional equipment, provides a signal that can be safely evaluated, guarantees a stable measurement setup and is very cost effective.

This object is achieved by the method having the features mentioned in claim 1. The sub claims specify advantageous embodiments of the invention. For illustration purposes, the invention is explained below in more detail using three figures. In the drawings

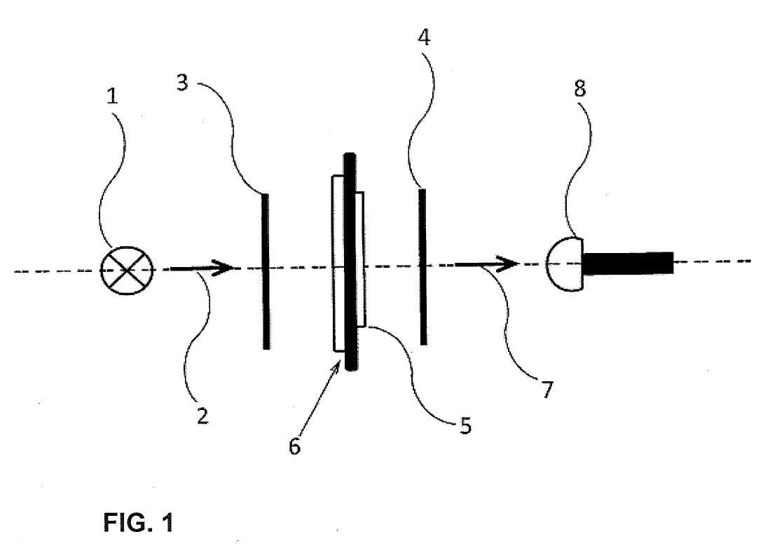

FIG. 1 shows the schematic measuring device of the LED biosensor,

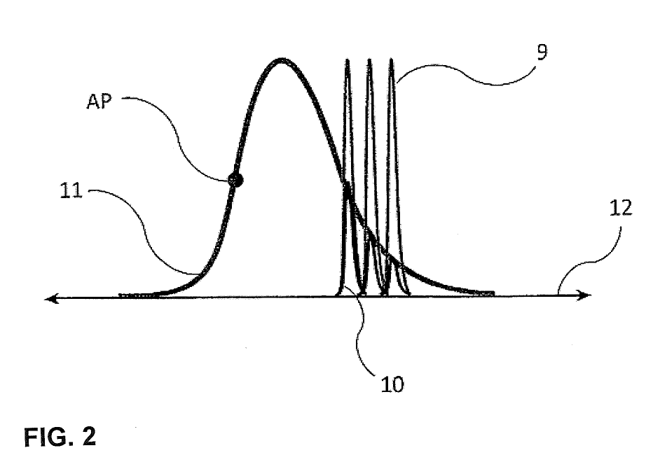

FIG. 2 shows a signal representation of the measuring method; and

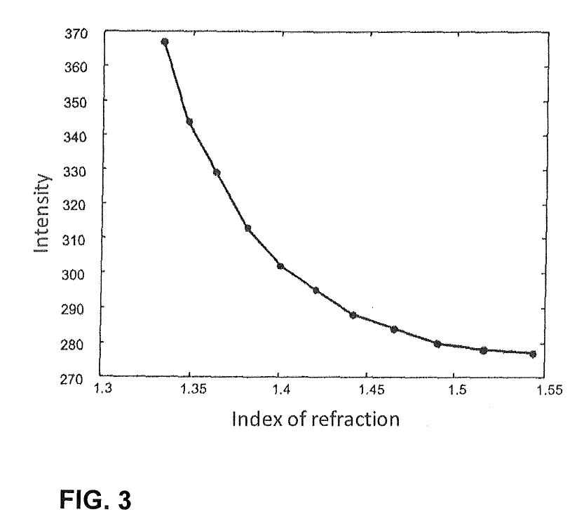

FIG. 3 shows a transmission intensity that has been determined.

The inventive device uses as its central elements a planar photonic crystal 6 that is inserted centrally in the measuring device. An electric light source 1 is in charge of the transmitted-light path having the light irradiation path 2 and the light emission direction 7 for which a spectrally narrow-band light source 1 is used. In the light irradiation direction 2, a polarization filter 3 is inserted between the light source 1 and the photonic crystal 6. The light that leaves in the light emission direction 7 is guided directly onto a light receiver 8. The entire transmitted-light path is designed as a straight optical bench.

The photonic crystal 6 can interact with the irradiated light 2 from the preferred direction, it being possible that one or more sharp resonances 9 can form in the transmission spectrum—as a function of the geometrical dimensions of the photonic crystal 6 and the indices of refraction of the materials. However, these resonances 9 are superimposed with interfering backgrounds light.

According to the invention, two polarization filters 3 and 4 are used that are introduced in a crossed manner in terms of their optical properties, to suppress the background light. The two crossed polarization filters 3, 4 block the transmitted light that does not interact with the photonic crystal 6. Only that spectral component of the light source 1 that is coupled into the photonic crystal 6 experiences a polarization rotation and can pass the second polarization filter 4.

So that biological substances can be detected, the surface of the photonic crystal 6 is functionalized using biological/organic substances 5, for example immobilized antibodies 5. According to the key-lock principle, the matching antibody can dock. This leads to a change in the index of refraction of the surrounding material, leading to a resonance shift 10. The size of this shift is a measure for the change on the surface of the photonic crystal 6.

According to the invention, of the spectrally limited spectrum 11 of the light source 1 that exhibits at least one edge, one of the edges is used as a working point (AP). An important feature of the method consists in the fact that the resonances 9 of the photonic crystal 6 are matched to the light source 1 that, despite their shift during the detection of biological substances 5, they only exist on the falling or the leading edge of the spectral transmission curve 11. If the spectral position of the residences 9 now changes, there is also a change in the intensity of the transmission in the exiting light beam relative to the light emission direction 7 and in the transmission resonance 10.

Mathematically, the function of the intensity is a convolution of the functions of the light source 1 and the resonances 9. The resonance shift is translated so to say into a change in intensity.

Using this evaluation method, a simple intensity measurement by means of a measuring device is sufficient for a quantitative determination of the change on the surface of the crystal. Multi functional experiments show that the spectrum for example of an LED is ideal for this evaluation/application. If the resonance shift to be expected is very small due to a low concentration of the substance to be detected (≦1 nm), a laser diode can be used as the light source 1. The spectral position of this laser diode should however be selected such that it is positioned on an edge of the resonance for the evaluation. The measurement method can also be used without losses in the results when the working point is situated on the rising edge of the light source.

Using this arrangement, even small resonance shifts can cause a significant signal change at an acceptable signal-noise ratio.

A further evaluation method can take place according to the invention by means of counting cells, in that the bright/dark spaces that are produced by the photonic crystal 6 and the crossed polarization filters 3, 4 when a biological substance 5 has been placed thereon, are counted by means of the light receiver 8 that is designed as an x/y matrix receiver.

To cause a change in the index of refraction on the surface of the crystal, water-sugar solutions having a varying concentration were used. The measurement effect that is based on the resonance shift results in changes in intensity of the resonances when the concentrations vary. FIG. 3 shows the total intensity of the transmission, measured using a power meter at the receiver output, as a function of the index of refraction of the water-sugar solution placed on the photonic crystal. With the illustrated course of the measurement, the working point was situated on the falling edge of the LED. The wavelength for the evaluation method is shown on the abscissa 12.

### LIST OF REFERENCE NUMERALS

1 light source
2 light irradiation direction
3 polarization filter
4 polarization filter
5 substance to be measured
6 photonic crystal
7 light emission direction
8 light receiver
9 crystal resonance
10 transmission resonance
11 spectral transmission curve
12 abscissa of the wavelength
AP working point

1. A device for detecting biological material, comprising
a light source (1) that radiates light (2) into an object (5),
a photonic crystal brought into contact with the object (5),
a detector (8) that detects light (7) transmitted through the photonic crystal (6) and the object (5),
a first polarization filter (3) arranged between the light source (1) and the photonic crystal (6), and
a second polarization filter (4) arranged between the object (5) and the detector (8) and rotated 90° relative to the first polarization filter (3), wherein the light source (1) exhibits a spectrally limited spectrum, the resonances in the photonic crystal (6) being in the edge range of the light source and must continue to lie in the edge range of the light source in the case of a resonance shift, the resonance shift being caused by the object (5) on the photonic crystal (6).

2. The device for detecting biological material according to claim 1, wherein the detector (8) is designed as an array.

3. A method for detecting biological material by means of irradiated light (2) in the photonic crystal (6), the object (5) being brought into contact with the photonic crystal (6), comprising the steps:
suppressing background light by means of crossed polarization filters (3, 4),
and transformation of the resonance shift into a change in intensity.

4.-6. (canceled)
